(19) United States
(12) Patent Application Publication
(10) Pub. No.: US 2014/0306087 A1
(43) Pub. Date: Oct. 16, 2014

(54) FAN BRACKET ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: BO TIAN, Shenzhen (CN); YU HAN, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/067,930

(22) Filed: Oct. 30, 2013

(30) Foreign Application Priority Data
Apr. 11, 2013 (CN) 2013101244954

(51) Int. Cl. F16M 13/02

(52) U.S. Cl. CPC F16M 13/02
USPC 248/674

(57) ABSTRACT

A fan bracket assembly includes a bottom plate, and a fan bracket. The bottom plate includes two engaging poles. Each engaging pole defines a hooking slot. Each of opposite ends of the fan bracket forms a resilient member, a clip opposite to the resilient member, and a latch extending from the resilient member toward the clip. Each engaging pole is sandwiched between the corresponding resilient member and clip. Each latch engages in the corresponding hooking slot.

### BACKGROUND

1. Technical Field

The present disclosure relates to a fan bracket assembly.

2. Description of Related Art

In a server, fans are mounted in a fan bracket, and the fan bracket is generally fastened to an enclosure of the server by screws. Accordingly, mounting the fan bracket to the enclosure with screws requires a screwdriver, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a fan bracket assembly.

FIG. 2 is an enlarged view of a circled portion II of FIG. 1.

FIG. 3 is an assembled, isometric view of FIG. 1.

FIG. 4 is an enlarged view of a circled portion IV of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

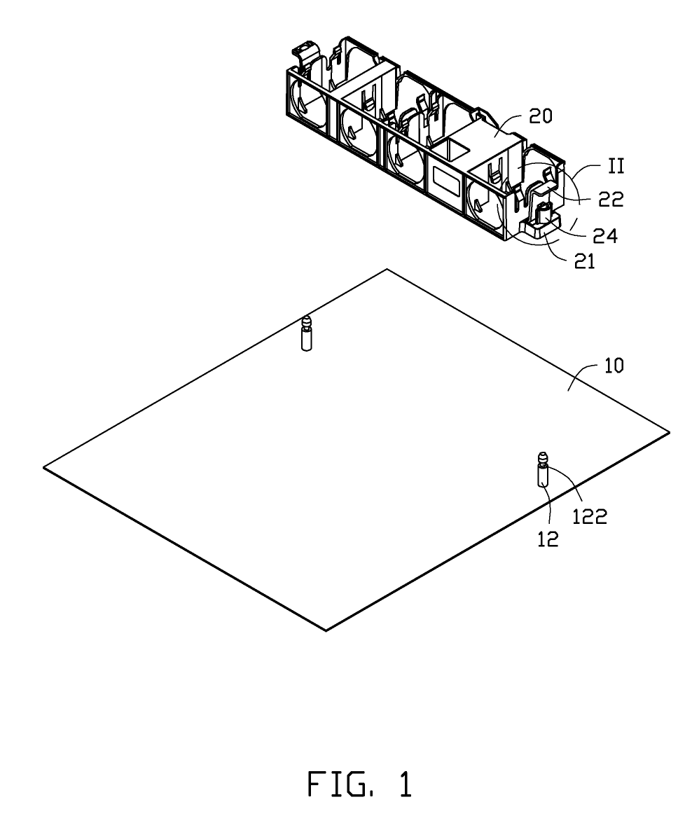

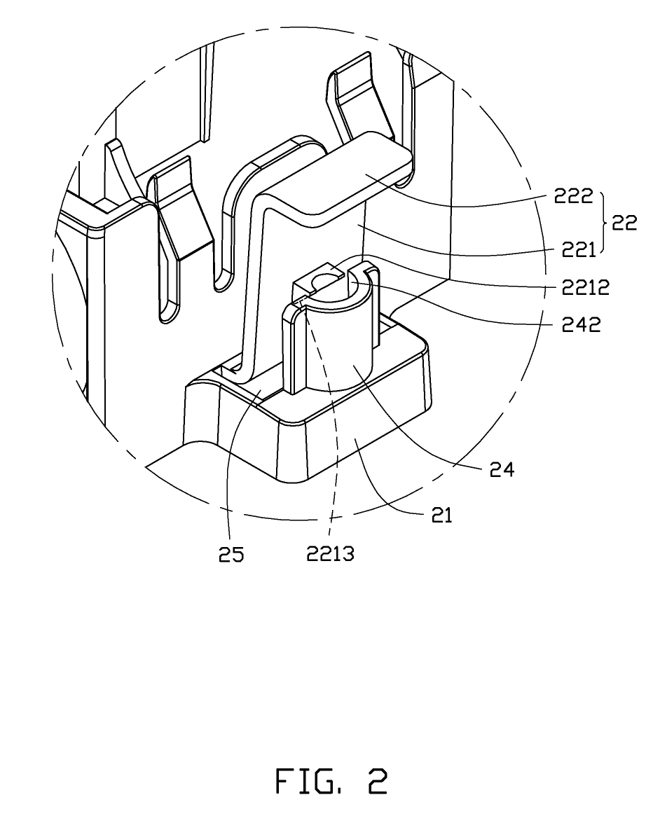

FIGS. 1 and 2 show an exemplary embodiment of a fan bracket assembly. The fan bracket assembly includes a bottom plate 10, and a fan bracket 20.

Two columnar engaging poles 12 extend up from the bottom plate 10. A hooking slot 122 is defined in a circumference of each engaging pole 12, near a top of the engaging pole 12.

Two blocks 21 are formed on lower portions of opposite ends of the fan bracket 20. A resilient member 22 extends up from each block 21. A clip 24 extends up from the block 21, at an outer side of the resilient member 22. The clip 24 is semicircular in cross-section. A through hole 25 is defined in the block 21, extending a top and a bottom of the block 21, and located between the resilient member 22 and the clip 24. The resilient member 22 includes an extension portion 221 extending up from the block 21, an operation portion 222 extending from a top of the extension portion 221 toward the clip 24, and a wedge-shaped latch 2212 extending from the extension portion 221 toward the clip 24. Tops of the latch 2212 and the clip 24 are substantially located at the same height. A slanting guiding surface 2213 is formed on a bottom of the latch 2212, facing the clip 24.

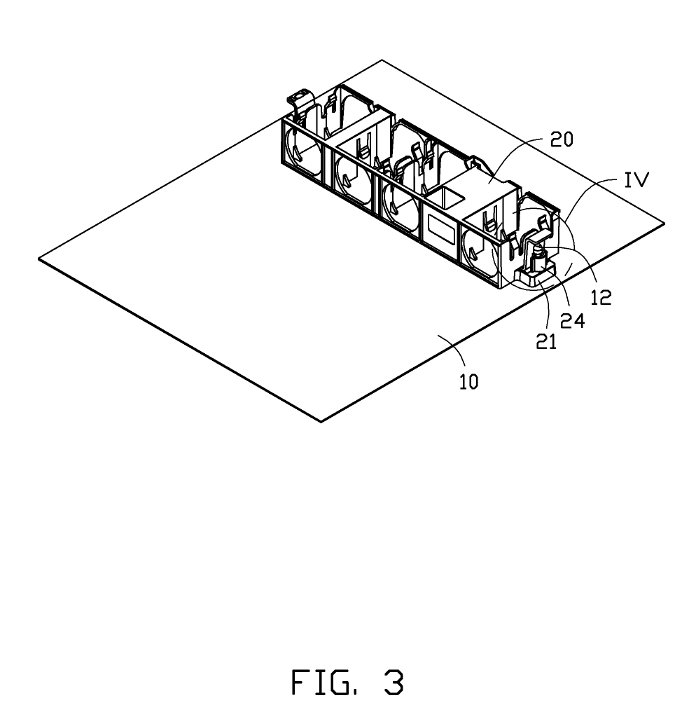

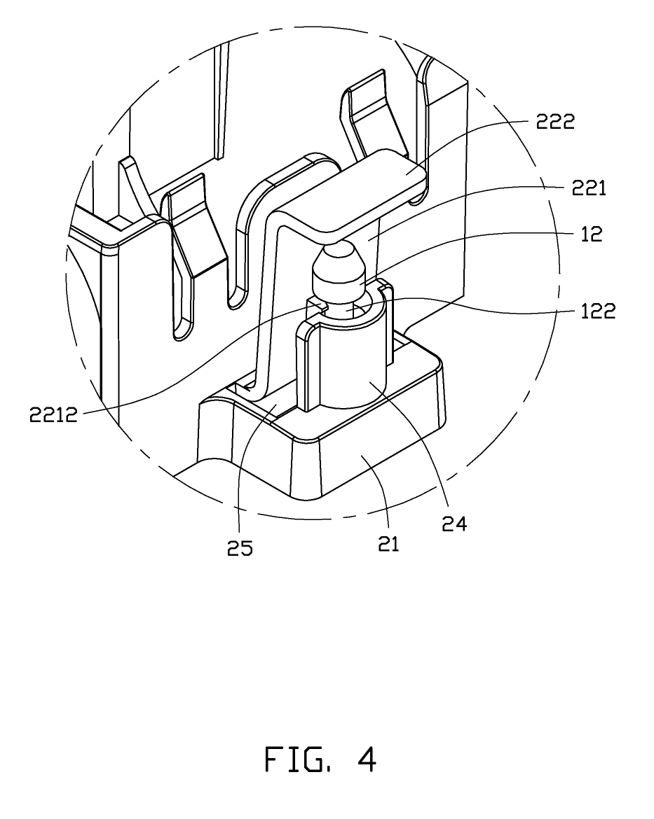

FIGS. 3 and 4 show that in assembly, the operation portions 222 are manipulated to deform the resilient members 22 away from the corresponding clips 24. The fan bracket 20 is placed above the bottom plate 10, and is moved down. The engaging poles 12 extend through the through holes 25 and abut against inner surfaces 242 of the clips 24. The fan bracket 20 is supported on the bottom plate 10. The operation portions 222 are released, restoring the resilient members 22. The latches 2212 engage in the corresponding hooking slots 122. Each engaging pole 12 is sandwiched between the corresponding clip 24 and extension portion 221. Thereby, the fan bracket 20 is fastened to the bottom plate 10.

In assembly, the operation portions 222 may not be operated. After the engaging poles 12 extend through the through holes 25, the tops of the engaging poles 12 abut against the guiding surfaces 2213 of the latches 2212, to deform the extension portions 221 away from the corresponding clips 24. When the hooking slots 122 are aligned with the latches 2212, the extension portions 221 are restored to allow the latches 2212 to engage in the hooking slots 122.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A fan bracket assembly, comprising:
a bottom plate comprising two engaging poles, each engaging pole defining a hooking slot; and
a fan bracket comprising two opposite ends, each of the opposite ends forming a resilient member, a clip opposite to the resilient member, and a latch extending from the resilient member toward the clip, each engaging pole being sandwiched between the corresponding resilient member and the corresponding clip, each latch engaging in the corresponding hooking slot.

2. The fan bracket assembly of claim 1, wherein each engaging pole is columnar, each clip is semicircular in cross-section.

3. The fan bracket assembly of claim 1, wherein each resilient member comprises an extension portion opposite to the corresponding clip, and an operation portion extending from a top of the extension portion toward the clip, the latches extend from the extension portions.

4. The fan bracket assembly of claim 3, wherein each engaging pole is sandwiched between the corresponding extension portion and clip.

5. The fan bracket assembly of claim 1, wherein the fan bracket comprises two blocks formed on the opposite ends of the fan bracket, the resilient members and the clips extend up from the corresponding blocks, each block defines a through hole located between the corresponding resilient member and clip, the engaging poles extend through the through holes.

6. The fan bracket assembly of claim 1, wherein each latch forms a slanting guiding surface facing the corresponding clip.
